(19) United States
(12) Patent Application Publication
(10) Pub. No.: US 2008/0251679 A1
(43) Pub. Date: Oct. 16, 2008

(54) Vehicle Seat, in Particular a Motor Vehicle Seat

(76) Inventors: Dan Stoia, Stadthagen (DE); Carsten Gaul, Meerbeck (DE)

Correspondence Address: ROBERT W. BECKER & ASSOCIATES, 707 HIGHWAY 333, SUITE B, TIJERAS, NM, 87059-7507, US

(21) Appl. No.: 12/104,365

(22) Filed: Apr. 16, 2008

(30) Foreign Application Priority Data
Apr. 16, 2007 (DE) 10 2007 018 101.0

(51) Int. Cl. B60N 2/12

(52) U.S. Cl. 248/429

(57) ABSTRACT

A vehicle seat, in particular a motor vehicle seat, comprising a first support location and a second support location for the pivotable accommodation of a tube. The first support location is an axially fixed bushing made of polymeric material that is adapted to be snap fitted with the tube to axially fix the tube in position. The second support location is adapted to accommodate the tube in an axially moveable manner.

The instant application should be granted the priority date of Apr. 16, 2007 the filing date of the corresponding German patent application DE 10 2007 018 101.0.

### BACKGROUND OF THE INVENTION

The present invention relates to a vehicle seat, in particular a motor vehicle seat having a first and second support means for the pivotable accommodation of a tube, whereby at least the first support means is formed by an axially fixed bushing made of polymeric material.

A vehicle seat of this type is known from DE 199 11 281 A1. To achieve as little mounting play of the tube as possible at low manufacturing expenditure, the tube is mounted in a bushing of polymeric material, which is provided with elastic elements for the biasing of the tube in the radial direction and in the axial direction. This approach allows compensation of manufacturing tolerances in the spacing between two support means or locations of the tube, without this resulting in twisting or rattling noises.

U.S. Pat. No. 6,457,775 B2 describes a further vehicle seat of the aforementioned type. This seat is longitudinally displaceably mounted on the floor of a vehicle via pairs of rails provided on both sides, whereby the seat can be arrested in desired longitudinally adjusted positions by arresting the upper rails in the lower rails. The release mechanism of the rail arrestment means includes two tubes, the respective ends of which can be rotatably connected in a bushing of polymeric material, with their other ends being fixedly connectable to the release lever, which is provided with a short tube and which together therewith is rotatably insertable into a further bushing of polymeric material. The bushings are formed on a component of polymeric material that is secured to flange elements that project from the upper rails, for example by being bolted thereto.

It is an object of the present invention to eliminate, or at least substantially reduce, the axial play of the tube that is present due to manufacturing tolerances in the spacing of the two support locations.

### SUMMARY OF THE INVENTION

This object, and other objects and advantages of the present invention, are realized by a vehicle seat where the first support means is an axially fixed bushing made of polymeric material, wherein this bushing is adapted to be snap fit with the tube to axially fix the tube in position, with the second support means being adapted to accommodate the tube in an axially moveable manner.

Due to this approach, the tube is axially fixed to the first support means or location, while on the opposite side, at the second support means or location, tolerances in the spacing between the two support means are accommodated in a freely sliding manner since the tube is axially moveably guided in the support means. The snap fit connection between the tube and the first support means ensures an easy installation of the tube. Due to the axial fixation of the tube, components that are connected therewith, for example a control lever, also have a precise axial position, so that they exhibit no tight fits and have no collisions with adjoining components.

It is to be understood that instead of the tube, it would also be possible to use a rod.

Further specific features of the present invention will be described in detail subsequently.

### BRIEF DESCRIPTION OF THE DRAWINGS

Three exemplary embodiments of the present invention will be described in conjunction with the accompanying schematic drawings, in which:

FIG. 1 is a side view of a motor vehicle seat, which is longitudinally adjustable via pairs of rails that are provided on both sides, and that is secured to the floor of a vehicle such that it can be arrested in various adjusted positions;

FIG. 2 is a perspective illustration of the pair of rails with assembled arresting means and release means seen at an angle from the front;

FIG. 3 is a front view of the illustration of FIG. 2;

FIG. 4 is a plan view of the illustration of FIG. 2;

FIG. 5 is a view taken in the direction of the arrow A in FIG. 4;

FIG. 6 is an enlarged cross-sectional illustration taken along the line A-A in FIG. 5;

FIG. 7 is an enlarged cross-sectional illustration taken along the line B-B in FIG. 5;

FIG. 8 is an enlargement of the dot-dash portion A in FIG. 2;

FIG. 9 is a cross-sectional view of a second exemplary embodiment taken along the line A-A in FIG. 5;

FIG. 10 is a cross-sectional view of the second embodiment taken along the line B-B in FIG. 5;

FIG. 11 is an enlargement of the dot-dash portion A in FIG. 2 pursuant to the second embodiment;

FIG. 12 is a perspective view of the illustration of FIG. 11 from the inner side;

FIG. 13 is a cross-sectional view of a third exemplary embodiment taken along the line A-A in FIG. 5;

FIG. 14 is a cross-sectional view of the third embodiment taken along the line B-B in FIG. 5; and

FIG. 15 is an enlargement of the dot-dash portion A in FIG. 2 pursuant to the third embodiment.

### DESCRIPTION OF SPECIFIC EMBODIMENTS

Referring now to the drawings in detail, the features common to all three embodiments of the invention will first be explained subsequently.

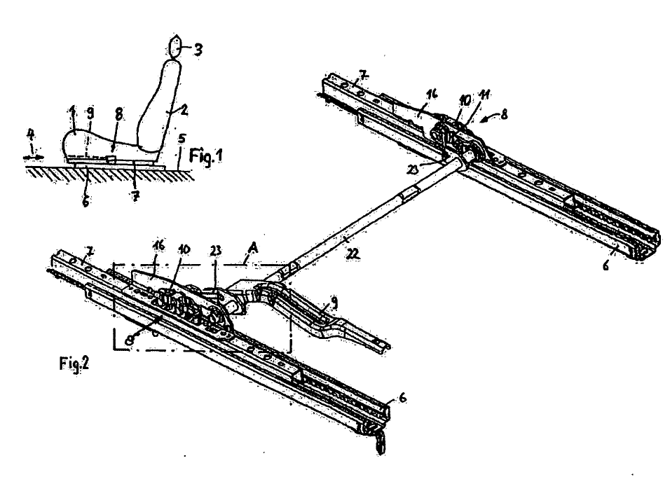

The motor vehicle seat shown in FIG. 1 has a sitting portion 1 and, secured thereto, a backrest 2 that can be adjusted with regard to its inclination and that is provided with a head support 3. The motor vehicle seat is mounted on the floor 5 of a vehicle so as to be longitudinally displaceable in the direction of the double arrow 4. For this purpose, disposed on each of its longitudinal sides is a respective pair of rails, each pair being comprised of a lower rail 6 and an upper rail 7. The lower rails 6 are secured to the floor 5 of the vehicle, for example by being bolted thereto, while the upper rails 7 are fixedly connected with the sitting portion 1 and are mounted in the lower rails 6 so as to be longitudinally displaceable. In order to be able to fix longitudinally adjusted positions of the motor vehicle seat that are obtained, arresting means 8 are provided via which the upper rails 7 can be fixed in position on the lower rails 6. To release the arresting means 8, a control lever 9 is provided that is connected with means for the release of the arresting means 8.

The release means include a rocker arm 10, which is preassembled on the pair of rails 6, 7 by means of a holding lever 11 that is made of polymeric material.

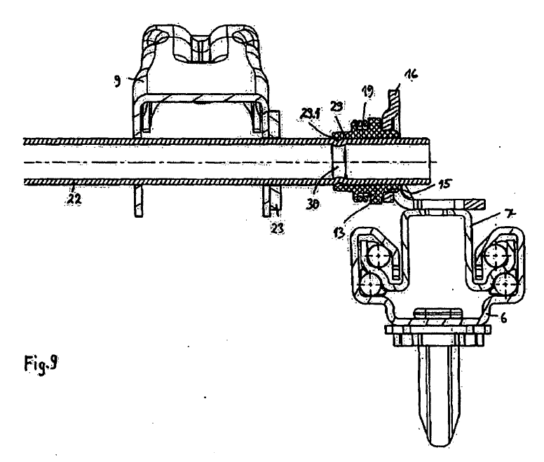

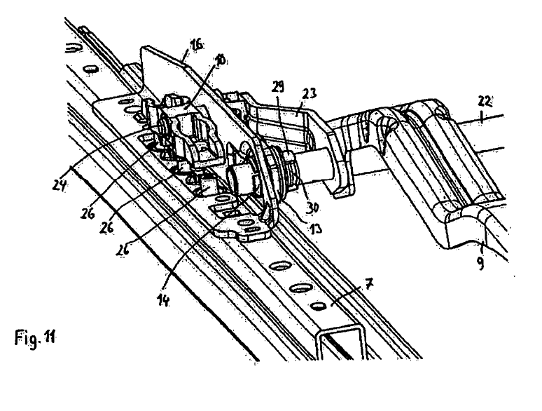

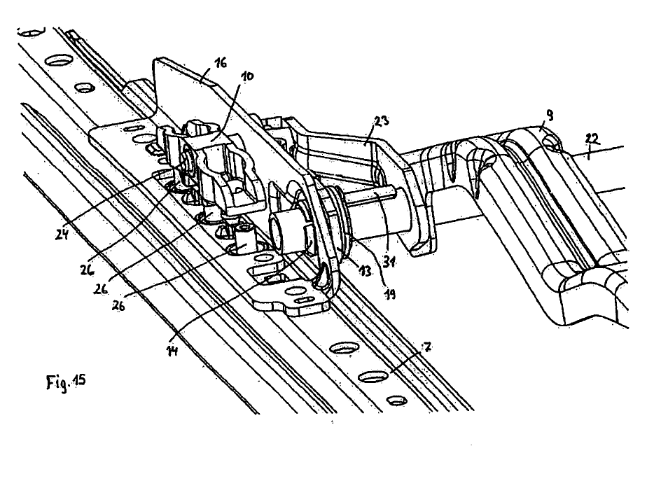

On one end, the holding lever 11 has a support journal 12, and on its other end has a support bushing 13 with detents 14. The support bushing 13 extends on both sides of the holding lever 11. During assembly, that end of the support bushing 13 that is provided with the detents 14 is inserted into a hole 15 that is provided in a bracket 16 that projects perpendicularly from the upper rail 7. In this connection, the support bushing 13 is inserted through the hole 15 to such an extent that the detents 14 latch behind the bracket 16 (FIGS. 7, 10, 14). The holding lever 11 is now non-detachably yet pivotably fixed in position on the bracket 16. The next step is the mounting of the rocker arm 10. The rocker arm has a support bushing 10.1 that is inserted from the outside through an elongated hole 17 that is provided in the bracket 16 and extends upwardly from the bottom. The support bushing 10.1 is inserted into the support journal 12 of the holding lever 11 until non-illustrated detents of the support journal 12 engage into an annular groove 18 that is provided on the free end of the support bushing 10.1. The rocker arm 10 is thereby non-detachably fixed in position on the holding lever 11. Subsequently, a leg spring 19 is mounted, the windings of which are pressed onto the inwardly facing end of the support bushing 13 of the holding lever 11. One leg 19.1 of the leg spring 19 then rests from below against a nose 20 that is angled off from the holding lever 11, while the other leg 19.2 is supported against a tongue 21 that is pressed out of the bracket 16. The holding lever 11 is thus upwardly biased, so that the support bushing 10.1 of the rocker arm 10 rests against the upper edge of the elongated hole 17.

With the rocker arms 10 preassembled in this manner, the pairs of rails 6, 7 are now provided for the final assembly. In this connection, the ends of a tubular release shaft 22, which is fixedly connected with the control lever 9, is inserted into the support bushings 13 of the holding levers 11 on both sides of the seat. At the same time, there is also effected a connection of the rocking arms 10 with the release shaft 22, whereby this connection is respectively effected via a metallic release lever 23, on the free end of which is riveted a bolt or pin 24 that extends parallel to the release shaft 22. This pin 24 is inserted into the support bushing 10.1 of the rocker arm 10, with this taking place on both sides of the seat.

The distance a (FIGS. 7, 10, 14) between the central axes of the release shaft 22 and of the pin 24 is subject to variations due to tolerances. Since in the final assembled state the support bushing 13 as well as the support journal 12 of the holding lever 11 must be disposed concentrically relative to the release shaft 22 and the pin 24 respectively, it is necessary for the length of the holding lever 11 to be able to follow these variations or fluctuations. Therefore, a wavy or corrugated portion 25 is provided between the support journal 12 and the support bushing 13; the thickness of the holding lever 13 is moreover reduced in this corrugated portion 25. The corrugated portion 25 makes it possible to axially extend or compress the holding lever 11 during insertion of the pin 24 into the rocker arm support bushing 10.1 that in turn is inserted into the support journal 12 of the holding lever 11, so that variations of the distance a between the central axes of the pin 24 and of the release shaft 22 can be compensated for.

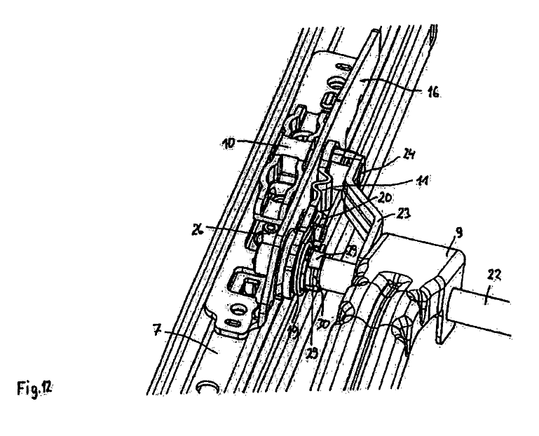

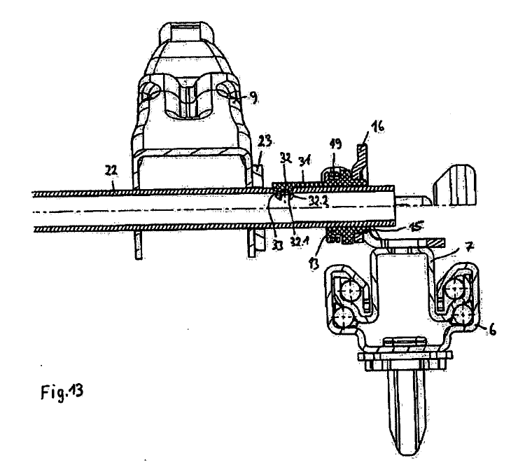

To release the interlocking between the upper rails 7 and the lower rails 6, the control lever 9 has to be raised. As a result, the release levers 23, which are fixedly located on the release shaft 22, pivot downwardly, taking along the rocker arms 10 via the pins 24. In so doing, the rockers arms 10 press upon push rods 26 (FIGS. 8, 11, 12, 15), whereby the pivotable arrangement of the rockers arms 10 upon the pins 24 of the release levers 23 ensures that the push rods 26 are uniformly actuated even if tolerances are present. The push rods 26 are part of the arresting means 8, the construction principle of which corresponds to that described in DE 199 18 600 B4, whereby reference is hereby made thereto. Notwithstanding this, the construction and function of the arresting means 8 is not important for understanding the present invention, and at any rate is known to one of skill in the art.

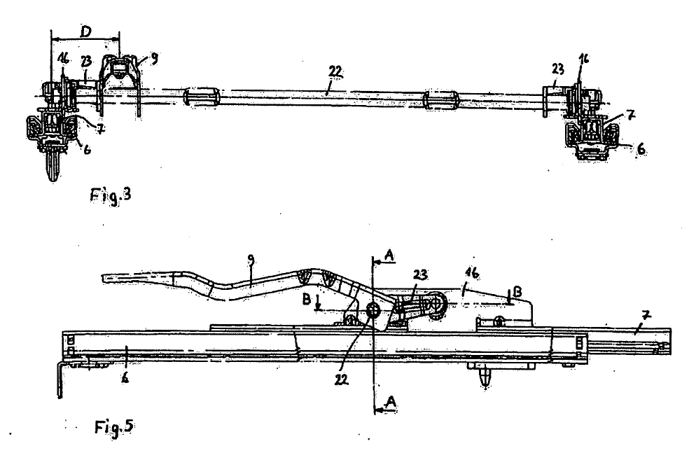

The problem with the construction described up to now is that the spacing between the pairs of rails 6 and 7 that are provided on both sides can fluctuate by up to 10 mm as a result of manufacturing. Due to these tolerances, the release unit, composed of release shaft 22, release lever 23, and rocker arms 10, has an axial play, relative to the release shaft 22, that at adjoining components of the motor vehicle seat can be too great, which can result in tight fits or collisions, for example of the control lever 9 with these components. Therefore, an elimination or reduction of the axial play of the release unit is desirable that leads to a fixed spacing D between the control lever 9 and the adjacent pair of rails 6, 7 (FIG. 3).

The problem described above is solved by snap fitting one end of the release shaft 22 with the associated support bushing 13 of the holding lever 11, as a result of which the release shaft 22, and hence the overall release unit, is axially fixed in position, while the opposite end of the release shaft 22 is axially moveably guided in the associated support bushing 13 of that holding lever 11. This axially slidable guidance of the release shaft 22 in this support location is not illustrated in the drawings.

Three embodiments are provided for the snap fitting of the release shaft 22 with the support bushing 13; these three embodiments will be explained subsequently with the aid of the drawings.

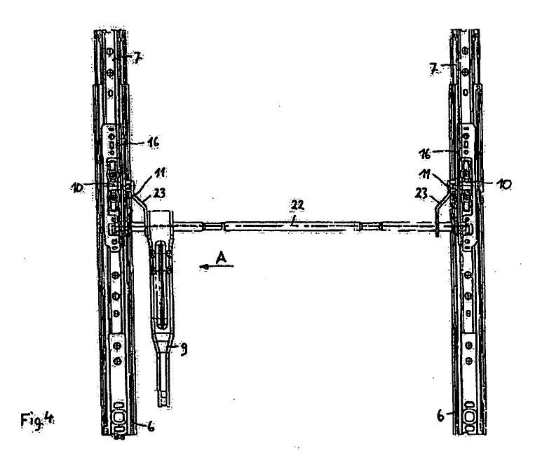

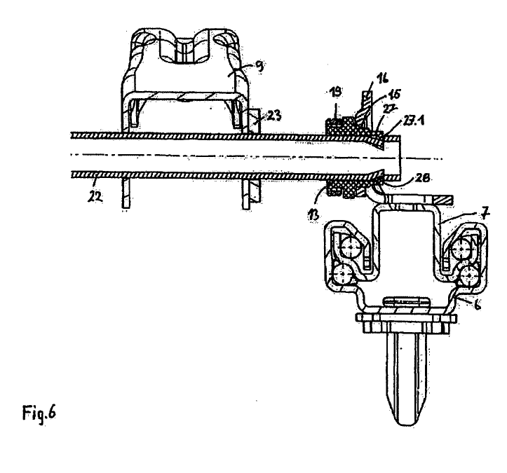

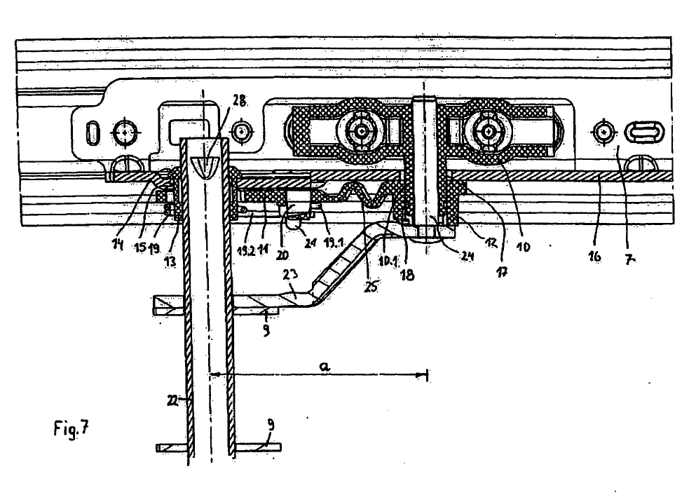

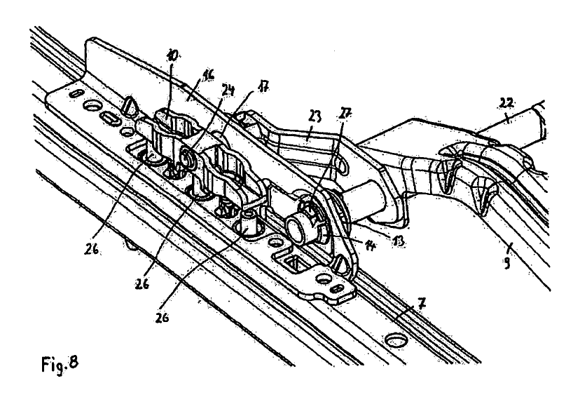

In the embodiment shown in FIGS. 2 to 8, two diametrically oppositely disposed tongues 27 are formed on that end of the support bushing 13 of the holding lever 11 that projects outwardly through the bracket 16. Radially inwardly extending, wedge-shaped noses 27.1 are disposed on the ends of the tongues 27. Stamped at that end of the release shaft 22 that is associated with this support bushing 13 are diametrically oppositely disposed recesses or depressions 28 that correspond to the wedge shape of the noses 27.1. During the assembly of the release shaft 22, its end is inserted into the support bushing 13. In so doing, the tongues 27 temporarily spring outwardly to then engage via their noses 27.1 into the depressions 28. The release unit, composed of the release shaft 22, the control lever 9, the release levers 23, and the rockers arms 10, is thus fixed axially in position on one of the pairs of rails 6, 7. With the support means or location disposed opposite the above described support position, the corresponding end of the release shaft 22 is axially moveably supported in the associated support bushing 13 of the holding lever 11 provided there; this is not illustrated in the drawing. This can be achieved by here omitting the tongues 27 of the support bushing 13 and the depressions 28 in the release shaft 22. However, advantageously only the depressions 28 are omitted, since then the holding lever 11 with the integrated support bushings 13 can have an identical configuration on both sides of the seat.

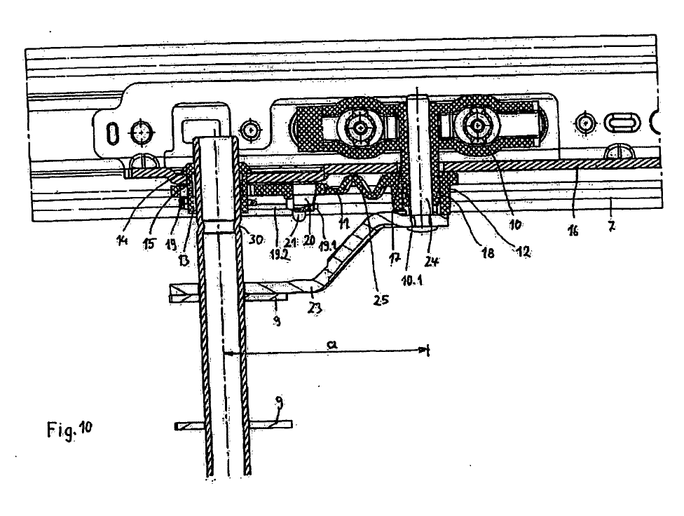

In the embodiment illustrated in FIGS. 9 to 12, relative to their installed position two diametrically oppositely disposed tongues 29 are formed on the inner ends of the support bushing 13, with spherical noses 29.1 being disposed on the ends of the tongues 29. Upon insertion of the associated end of the release shaft 22, these noses 29.1 engage into an annular groove 30 that is stamped or otherwise formed in the release shaft 22, whereupon the release shaft is axially fixed at this support location. For the oppositely disposed support location, applicable is the same situation as that described in conjunction with the first embodiment.

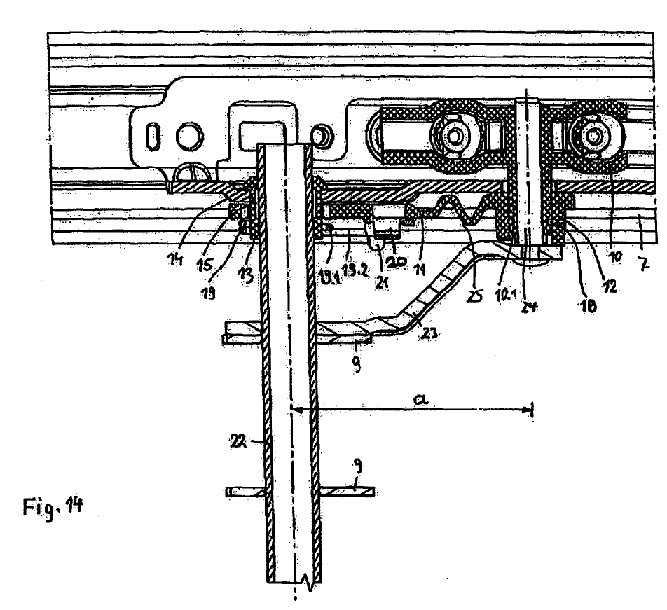

FIGS. 13 to 15 show a further embodiment of the present invention. Here, again relative to its installed position, only one tongue 31 is provided on the inner end of the support bushing 13. A radially inwardly projecting, snap fastener type projection 32 is formed on the end of the tongue 31. This projection 32 is comprised of individual resilient arms 32.1, which are arranged on a circle and on the ends of which are disposed hook-shaped noses or detents 32.2. A round hole 33 is provided in the associated end of the release shaft 22. For the axial fixing of the release shaft 22 in position on the associated pair of rails 6, 7, the projection 32 is pressed into the hole 33, so that the noses 32.2 of the projection 32 latch behind the inner wall of the release shaft 22.

Reference is again made to the first embodiment with respect to the opposite support location.

In the aforementioned embodiments, the support bushing 13 was described as an integral substituent of a further component, namely the holding lever 11. However, it is, of course, also within the scope of the present invention that this support bushing 13 can be a separate component.

The specification incorporates by reference the disclosure of German priority document DE 10 2007 018 101.0 filed Apr. 16, 2007.

The present invention is, of course, in no way restricted to the specific disclosure of the specification and drawings, but also encompasses any modifications within the scope of the appended claims.

What I claim is:

1. A vehicle seat, comprising:
a first support means for the pivotable accommodation of a tube (22), wherein said first support means is an axially fixed bushing (13) made of polymeric material, and wherein said bushing is adapted to be snap fit with said tube (22) to axially fix said tube in position; and
a second support means for the pivotable accommodation of said tube (22), wherein said second support means is adapted to accommodate said tube in an axially moveable manner.

2. A vehicle seat according to claim 1, wherein said bushing made of elastomeric material (13) is provided with at least one axially extending tongue (27, 29, 31) that is adapted to resiliently yield, further wherein a first snap fit means (27.1, 29.1, 32) is formed on said tongue (27, 29, 31), further wherein a second snap fit means (28, 30, 33) is provided on said tube (22), and wherein said first snap fit means (27.1, 29.1, 32) is adapted to cooperate with said second snap fit means (28, 30, 33).

3. A vehicle seat according to claim 2, wherein said first snap fit means (29.1) is a nose that is formed on said tongue (29), and wherein said second snap fit means (30) is an annular groove that is provided on said tube (22).

4. A vehicle seat according to claim 2, wherein said first snap fit means (27.1) is a nose that is formed on said tongue (27), and wherein said second snap fit means (28) is a depression that is stamped into said tube (22).

5. A vehicle seat according to claim 2, wherein said second snap fit means (33) is a hole formed in said tube (22), further wherein said first snap fit means (32) is a projection that is formed on an end of said tongue (31), further wherein said projection (32) is comprised of individual resilient arms (32.1) having an arrangement that is adapted to the shape of said hole (33), and wherein ends of said resilient arms (32.1) are provided with noses or detents (32.2) that upon pressing of said projection (32) into said hole (33) are adapted to engage behind an inner wall of said tube (22).

6. A vehicle seat according to claim 1, wherein said bushing made of polymeric material (13) is provided with holding means (14) for axial fixation of said bushing (13) in said first support means (16, 15).

7. A vehicle seat according to claim 1, wherein said bushing made of polymeric material (13) is a separate component.

8. A vehicle seat according to claim 1, wherein said bushing made of polymeric material (13) is a substituent of another component (11).
